(19) United States
(12) Patent Application Publication
(10) Pub. No.: US 2017/0219240 A1
(43) Pub. Date: Aug. 3, 2017

(54) METHOD AND APPARATUS FOR A FAN AUTO ADAPTIVE NOISE

(71) Applicant: Avaya Inc., Santa Clara, CA (US)

(72) Inventors: Angelo Li Quadri Cassini, Ancona (IT); Simone Angelelli, Ancona (IT); Stefano Carnevali, Ancona (IT); Stefano Filippetti, Ancona (IT); Andrea Pasquinelli, Ancona (IT)

(21) Appl. No.: 15/014,818

(22) Filed: Feb. 3, 2016

(51) Int. Cl. F24F 11/00; G05B 15/02; G06F 1/20

(52) U.S. Cl. CPC F24F 11/0079; G06F 1/20; G05B 15/02

(57) ABSTRACT

The disclosure is related to a cooling system that includes a thermal sensor to determine a temperature in an interior of the computational device, a sensor to determine at least one of a noise level in proximity to the computational device or a presence or absence of a human user in spatial proximity to the computational device, a fan to cool a component of the computational device, a microprocessor, and a computer readable medium comprising fan control rules. The fan control rules cause the microprocessor to increase a speed of the fan in response detecting a noise level in proximity to the computational device greater than a selected magnitude or an absence of a human user in spatial proximity to the computational device.

### FIELD

The disclosure relates generally to cooling electronic computational devices and particularly to mechanically cooling electronic communication devices.

### BACKGROUND

As processors, graphics cards, RAM and other components in computers have increased in speed and power consumption, the amount of heat produced by these components, as a side-effect of normal operation, has also increased. These components need to be kept within a specified temperature range to prevent overheating, instability, malfunction and damage leading to a shortened component lifespan. A computer fan is any fan inside, or attached to, a computer case used for active cooling, and may refer to fans that draw cooler air into the case from the outside, expel warm air from inside, or move air across a heat sink to cool a particular component.

Cooling fans on electronic devices, such as computers, communication endpoint devices, and other electric equipment, are often located in offices, conference rooms, or other rooms having strict ambient noise requirements. Cooling fan noise is dependent on room temperature, which can vary seasonally and geographically. Higher room temperatures increase cooling requirements and require higher fan speeds. Higher fan speeds can not only increase noise but also increase power consumption and decrease fan life.

### SUMMARY

These and other needs are addressed by the various aspects, embodiments, and/or configurations of the present disclosure. The disclosure is directed to a cooling system for an electronic computational device that includes one or more heat generating components, such as an integrated circuit.

The cooling system can include:

a thermal sensor to sense a temperature in an interior of the computational device;

a sensor to sense a parameter other than temperature of the interior;

a fan to cool a component of the computational device;

a microprocessor; and

a computer readable medium comprising fan control rules.

The fan control rules cause the microprocessor to modulate or vary a speed of the fan based on the sensed interior temperature and other sensed parameter.

The sensed parameter can be a noise level in proximity to the computational device and/or a presence or absence of a human user in spatial proximity to the computational device.

The fan control rules can cause the microprocessor to increase a speed of the fan in response detecting a noise level in proximity to the computational device greater than a selected magnitude or an absence of a human user in spatial proximity to the computational device.

The fan control rules can decrease a speed of the fan in response to detecting a noise level in proximity to the computational device less than a selected magnitude or a presence of a human user in spatial proximity to the computational device.

The present disclosure can provide a number of advantages depending on the particular aspect, embodiment, and/or configuration. The fan control system can selectively run at a certain fan noise level when there is ambient noise present, measured, and controlled by multiple sensors. The system can cool down computational devices and components thereof more than the conventional methodology of controlling fan speed based only on interior case temperature. Lower operating temperatures can provide increased Mean Time Between Failures (MTBF) for the computational device, lower case or chassis cover and interior temperatures, longer system and component life, and less power consumption, all without uncomfortable or distracting noise emissions for a user. The system can, through use of multiple sensors to manage case temperature and fan noise emissions, allow better fan speed management than conventional solutions, thereby allowing better compliance with product requirements regarding operating temperatures and fan noise emissions. In conventional solutions, fan speed increases as the operating or interior case temperature increases regardless of what is happening in the surrounding environment. The system, in contrast, can use multiple sensors to manage intelligently when to activate the fan and at what fan speed while maintaining fan noise emissions at acceptable levels.

These and other advantages will be apparent from the disclosure.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

A “computer fan” is any fan inside, or attached to, a computer case used for active cooling, and may refer to fans that draw cooler air into the case from the outside, expel warm air from inside, or move air across a heat sink to cool a particular component.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a cross-sectional view of an electronic device according to an embodiment;

FIG. 2 is a block diagram of a control system according to an embodiment;

FIGS. 3A and 3B are logic flow schematics for operation of the control system;

FIG. 4 is a plot of fan speed (RPM) (vertical axis) against fan noise (dBA) (horizontal axis);

FIG. 5 is a plot of fan speed (% of max. fan setting) (vertical axis) against interior case temperature fan (degrees Celsius) (horizontal axis);

FIG. 6 is a lookup table for measured ambient noise (dBA) (vertical axis) against fan speed increase (%) (horizontal axis);

FIG. 7 is a lookup table for measured case temperature (degrees Celsius) (vertical axis) against pulse width modulation (PWM) fan speed control (% max. fan setting);

FIG. 8 is a plot of interior case temperature or fan speed (degrees Celsius or RPM as appropriate) (vertical axis) against time lap (minutes) (horizontal axis);

FIG. 9 is a plot of fan noise level (dBA) (vertical axis) against time lap (minutes) (horizontal axis);

FIG. 10 is a plot of interior case temperature/fan RPM (degrees Celsius/RPM) (vertical axis) against time lap (minutes) (horizontal axis) (upper graph); and

FIG. 11 is a plot of interior case temperature (degrees Celsius) (vertical axis) against temperature sensor location (Tcase_inlet, Tcase, or Tcase_outlet) (horizontal axis) (lower graph).

### DETAILED DESCRIPTION

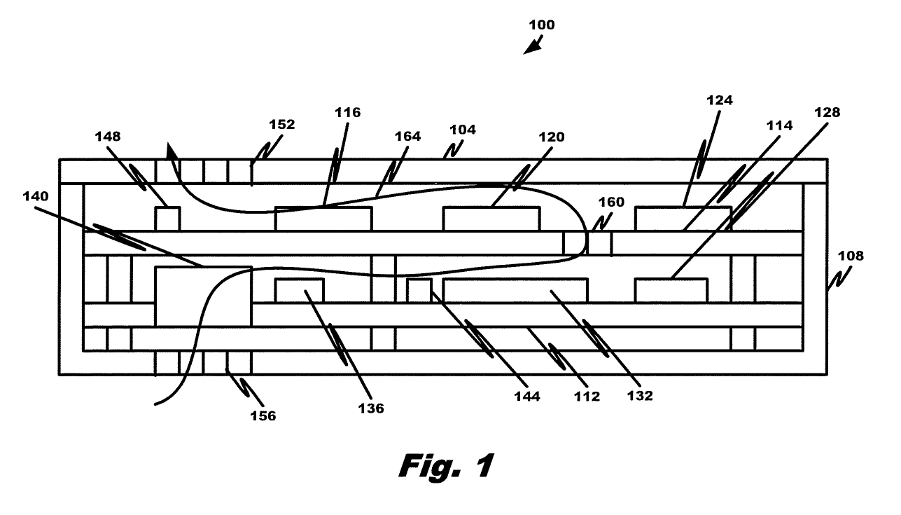

With reference to FIG. 1, a computational device according to an embodiment is depicted. The computational device 100, which can be a PC, laptop, or tablet computer, computer peripheral, a telecommunication device or platform, gateway, router, wireless access point, or any other mechanically cooled device, includes an outer casing housing having upper and lower sections 104 and 108, respectively, plural circuit boards 112 and 114, each including one or more heat generating integrated circuits (such as integrated circuits 116, 120, 124, 128, 132, and 136), a fan 140, such as a pulse width modulation controlled fan, and thermal sensors 144 and 148 for measuring the internal temperature of the case housing. The integrated circuits can be, by way of non-limiting example, a microprocessor, digital memory chip (e.g., RAM), driver, field programmable gate array, or application-specific integrated circuit (e.g., sound or graphics card). The upper and lower sections 104 and 108, and board 114 can each include a vent or perforated section (or other passageway) 152, 156, and 160, respectively, to permit air flow (shown by air flow path 164) in response to fan operation. The computational device 100 can include one or more heat sinks (not shown) to lower operating temperatures.

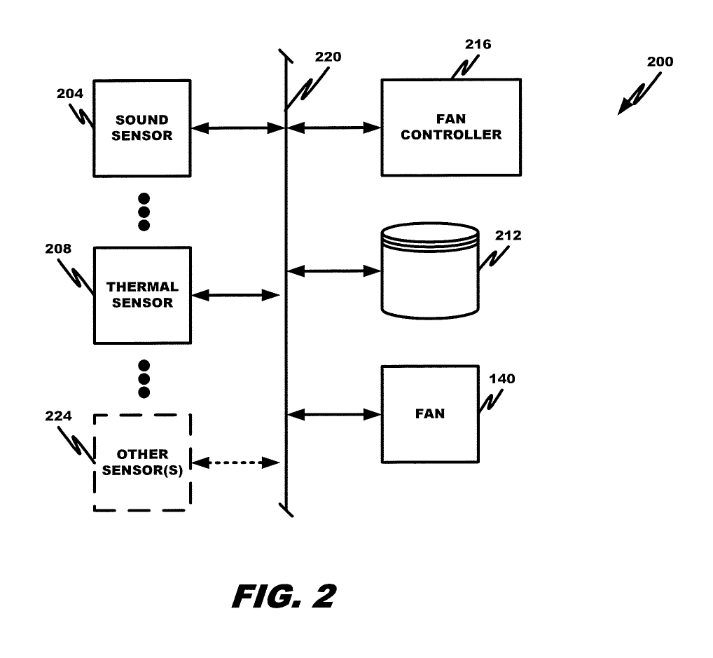

FIG. 2 depicts a control system 200 (also referenced herein as the Fan Auto Adaptive Noise or FAAN system) according to an embodiment. The control system 200 includes one or more sound sensors 204, one or more temperature sensors 208 (such as thermal sensors 144 and 148), the fan 140, other sensor(s) 224, a database or computer readable medium 212, and a fan controller 216, in communication by a network or bus 220.

The sound sensor 204 can be any sound detecting device, such as a microphone or array of microphones with processing circuitry. The processing circuitry typically includes an amplifier and spectral audio filters. The spectral audio filters can be any hardware and/or software able to isolate and remove the noise of the fan from the amplified ambient noise profile. The spectral audio filters can be, for example, a linear or nonlinear filter such as those having local characteristics (e.g., time-frequency filters), a noise reduction software algorithm, and the like that have been tuned or configured to remove the amplified noise print or profile of the fan from the amplified ambient noise profile. The noise print or profile of the fan can be determined by measuring the spectral sound profile or emissions of the fan in the absence of ambient noise. The sound detecting device can be a sound metering device, such as a sound level meter, octave filter, personal noise dosimeter, or measurement microphone that measures sound by a conventional sound level meter, integrating-averaging sound level meter, and/or integrating sound level meter.

The temperature sensor 208 can be a mechanical, electrical, or integrated circuit sensor. Examples of mechanical temperature sensors include a thermometer and bimetal sensor, electrical temperature sensor include a thermistor, thermocouple, resistance thermometer, and silicon bandgap temperature sensor, and integrated circuit sensor include analog and microchip devices.

The (optional) other sensors 224 can include a number of optional sensors including a timing device, such as a clock, to provide timing signals and/or a sensor to detect a person, such as passive infrared sensor (e.g., proximity sensors) to detect body thermal emissions, motion sensor to sense body movement, wearable device detector (such as RFID (or radio frequency identification)) to detect a wearable device on the person, video processing to detect a person's image in a video of an area in spatial proximity to the computational device, and user interaction with the computational device 100, such as tactile or voice input received by a user interface, and the like. These sensors 224 determine when the computational device 100 operating after hours or that the computational device 100 operating when no person is within a selected spatial proximity to the computational device 100.

The fan controller 216 receives signals from the sound sensor 204 and thermal sensor 208 and/or other sensors 224 and, using lookup tables in the computer readable medium 212, applies rules to the received signals and, in response, issues control signals to the fan 140. The lookup tables can take many forms. In one form, the mapping data structures are a two- or more dimensional lookup table that maps one or more sensed parameters, such as ambient noise, temperature, and/or other sensor readings, against fan speed and/or fan speed multiplication or modification factors. As will be appreciated, the lookup table is an array that replaces runtime computation with a simpler array indexing operation. The indexing operation can be one or more of a simple lookup in an array, an associative array, or a linked list, a binary search in an array or an associative array, a trivial hash function, and the like. The savings in terms of processing time can be significant, since retrieving a value from memory is often faster than undergoing an expensive computation or input/output operation. Other forms of mapping data structures can be employed depending on the application. Alternatively, the relationships in the lookup tables can be computationally determined in substantial real time, as in runtime computation.

The fan 140 can be any type of cooling fan or blower, whether using rotational speed and/or static air pressure to cool the interior casing or component thereof. For example, the fan can be a case mount fan, CPU fan, graphics card fan, chipset fan, expansion slot fan, hard disk fan, optical drive fan, and/or memory fan. In some applications, the fan controller 216 controls multiple fans concurrently using a common set or differing sets of rules.

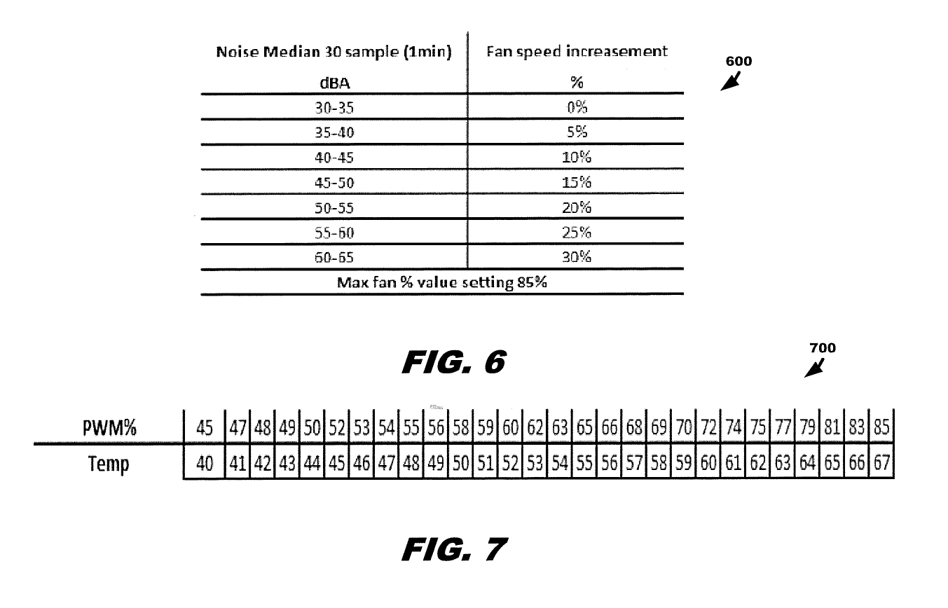

Examples of the ambient noise:fan speed increase lookup table 600 is shown in FIG. 6, and of the measured temperature:fan speed (or setting) lookup table 700 is shown in FIG. 7. This table 600 has various measured ambient dBA noise levels (which are filtered to exclude the noise of the fan itself) indexed against a multiplication factor for the fan speed value produced by the measured temperature:fan speed (or setting) lookup table 700. The lookup table 700 indexes the pulse width modulation (%) for the fan 140 against the measured interior casing temperature (degrees Celsius). By way of example, if the temperature sensor 208 measures an interior casing temperature of 60 degrees Celsius and the sound sensor 204 measures an ambient noise level (excluding any contribution made by the fan itself) of 60 dBA, the fan controller 216 issues a control signal to the fan to increase its setting F_{retting} to 90 PWM % (F_{setting}=72% (from lookup table 700)×1.25 (or a fan setting multiplication factor for an ambient noise level of 60 dBA from lookup table 600). For temperatures over 65 degrees Celsius, the lookup table 600 caps the flat fan setting multiplication factor at 85% or 1.85× the fan setting from lookup table 700.

While fan control is discussed with reference to a pulse-width modulation (PWM) control, it is to be understood that any type of control signal can be employed. Other example methodologies include, without limitation, thermostatic, linear voltage regulation, resistor, diode, volt modding, and integrated or discrete linear regulators.

Generally, the rules are based on the assumption that fan control is needed when a user is physically nearby and the ambient noise is low. In that situation, the fan noise can reach a level that can be heard by the user. For example, during a conference call, a user is focused on the meeting and pays less attention to ambient noise, including the noise of the fan. Taking advantage of the user focus on the meeting, the fan controller 216 can increase the fan speed, up to a predetermined level, without the user noticing the increased ambient noise.

In most applications, the rules are based on a thermal picture of the computational device 100 and on the ambient noise profile. The fan speed is proportional to the interior casing temperature and increased by a factor based on the ambient noise. The ambient noise multiplication can be overridden if the interior casing temperature exceeds a predetermined level.

Generally, the rules require the fan speed to increase with the ambient noise (less fan noise) (such as from conversations, air conditioning noise, desktop or laptop noise such as from music or a tactile keyboard, weather related noise, and other types of background noise, detected in the ambient environment). Fan noise is commonly maintained at a level less than about 36 dBA at a distance of about 10 cm measured in the absence of ambient noise. A selected thermal sensor value, or temperature reading, defines the limit of application of the algorithm.

With this in mind, an exemplary set of rules is as follows:

When the sensed interior casing temperature is less than a first temperature threshold or the measured ambient noise level is no more than a first noise threshold, the fan is operated in accordance with the fan lookup table regardless of the measured ambient noise level. Typically, the fan is operated at a speed to maintain its noise at less than 36 dBA at 10 cm in an otherwise sound-free environment.

When the sensed interior casing temperature is greater than the first temperature threshold and the measured ambient noise level is more than a first noise threshold, the fan is operated in accordance with the appropriate fan setting from the fan setting lookup table 700 increased by the appropriate multiplication factor from the lookup table 600.

When the sensed interior casing temperature is greater than a second temperature threshold or when a person is not sensed or deemed to be in spatial proximity to the computational device 100, the fan is operated in accordance with the fan lookup table regardless of the measured ambient noise level.

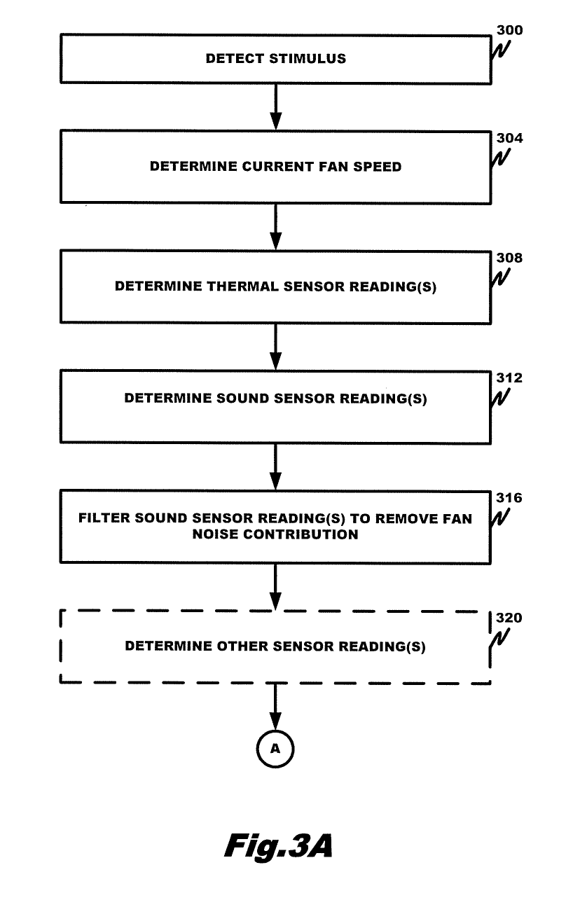

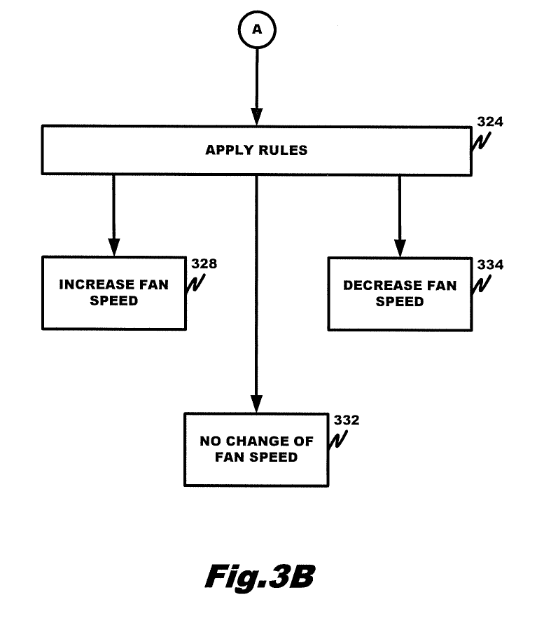

The operation of the control system 200 will now be discussed with reference to FIGS. 3A and 3B.

With reference to FIG. 3A, the fan controller 216, in step 300, detects a stimulus, such as passage of time, an interior case temperature reaching a determined level, detection of ambient noise above a determined level, a person in spatial proximity to the computational device 100, and the like.

In step 304, the fan controller 216 determines a current fan speed or setting as a benchmark.

In step 308, the fan controller 216 determines a current thermal sensor 208 reading indicative of an interior case temperature at one or more locations within the case of the computational device 100. When the temperature is determined at multiple locations, the temperature readings can be weighted or averaged, as desired, to arrive at a single temperature value.

In step 312, the sound sensor 204 measures ambient noise at one or more locations in spatial proximity to the computational device 100. When the ambient noise is measured at multiple locations, the noise readings can be weighted or averaged, as desired, to arrive at a single noise value.

In step 316, the sound sensor 204 filters, or removes, from the total measured ambient noise profile at least most of the spectral sound components attributable to fan noise. The filtered ambient noise measurement(s) are provided to the fan controller 216.

In optional step 320, the fan controller 216 determines other sensor readings to determine if a person is in spatial proximity to the computational device 100. When a person is determined to be in spatial proximity to the computational device 100, the fan is operated in accordance with the fan lookup table 700 regardless of the measured ambient noise level. When no person is determined to be in spatial proximity to the computational device 100, both lookup tables 600 and 700 can be used.

In step 324, the fan controller 216 applies the rules above to the collected sensor readings and increases the fan speed (step 328), decreases the fan speed (step 334), or makes no change to the current fan speed (step 332).

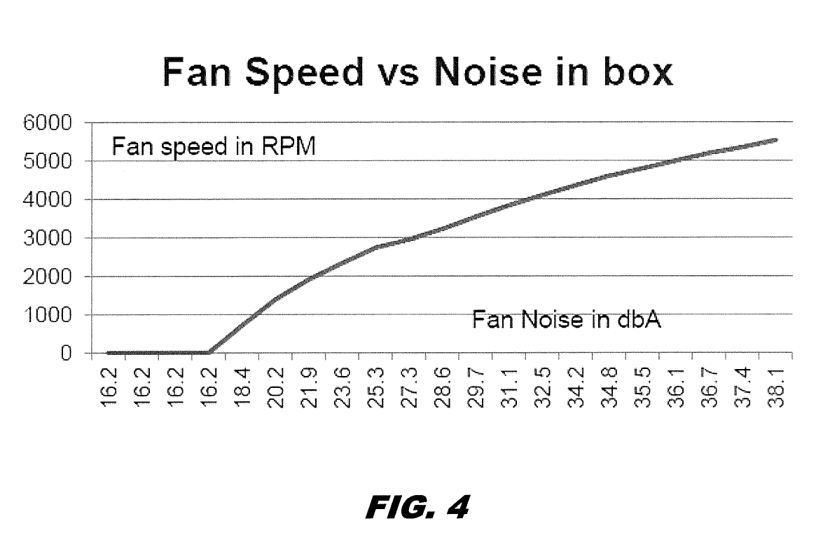

The effectiveness of the control system will now be discussed with reference to FIGS. 4-5 and 8-11.

FIG. 4 depicts that the ambient noise profile of the fan is directly proportional to fan speed measured in RPM.

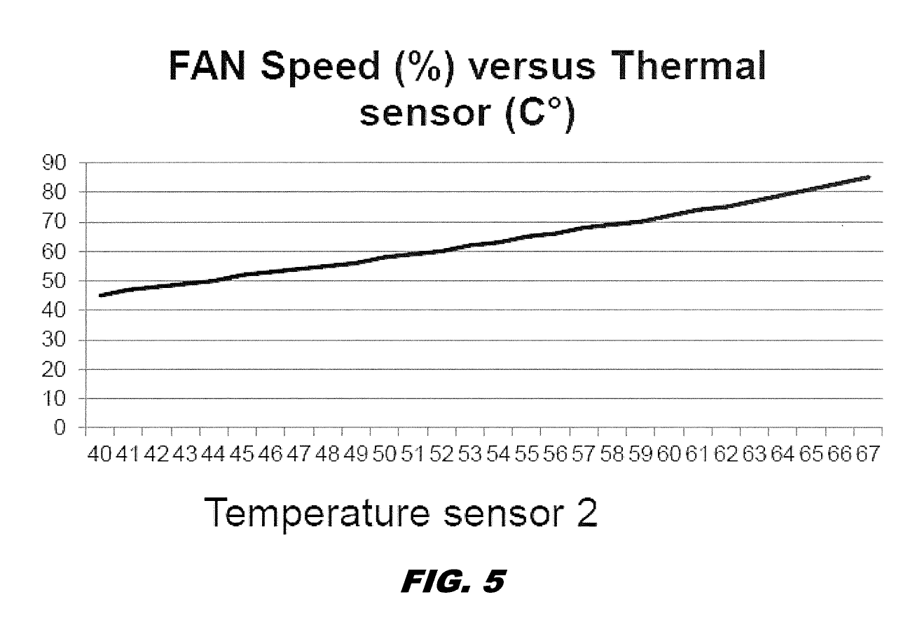

FIG. 5 depicts that the fan speed (PWM %) increases in a manner directly proportional to interior casing temperature. This is the case when only lookup table 700 is employed.

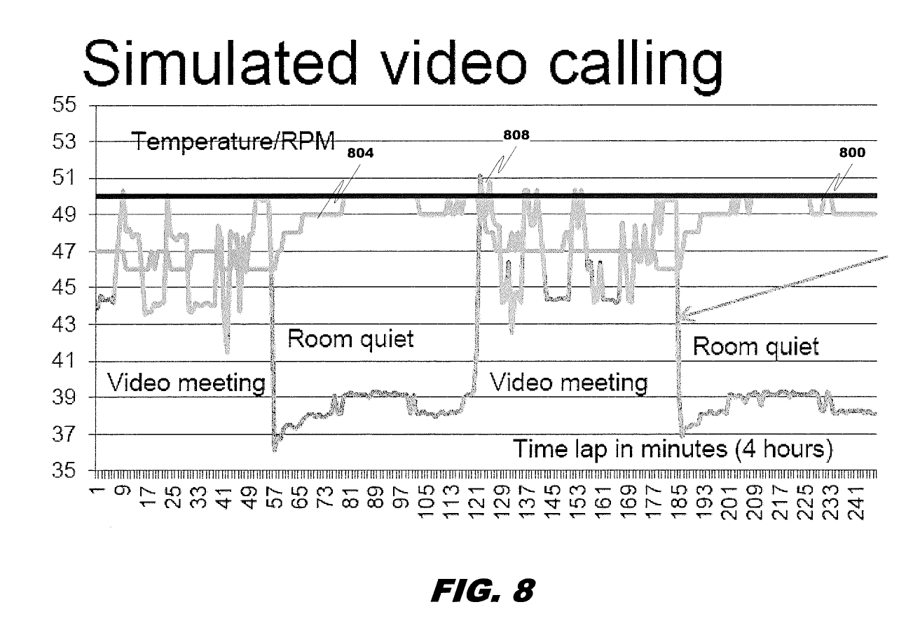

FIG. 8 depicts the fan speed (curve form 808) when the lookup tables 600 and 700 are employed, interior casing temperature (curve form 804) when the lookup tables 600 and 700 are employed, and interior casing temperature (curve form 800) when only lookup table 700 is used. This graph shows that the interior casing temperature can be reduced significantly using lookup tables 600 and 700.

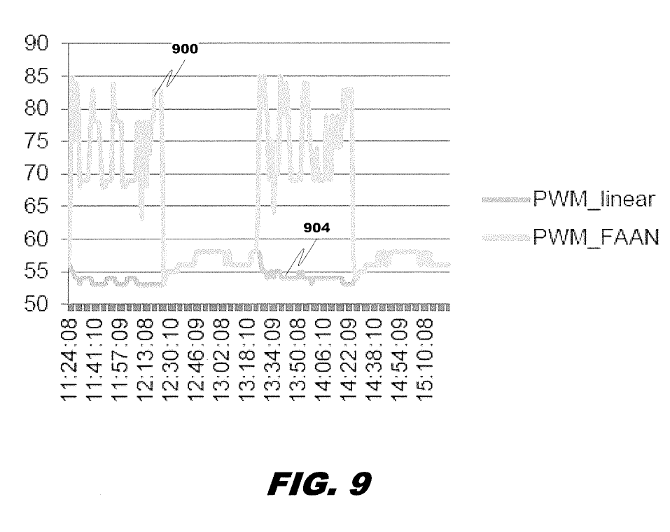

FIG. 9 shows the curve form 900 for fan noise using the lookup tables 600 and 700 jointly (PWM_FAAN) as opposed to curve form 904 for fan noise using only the lookup table 700 (PWM_linear).

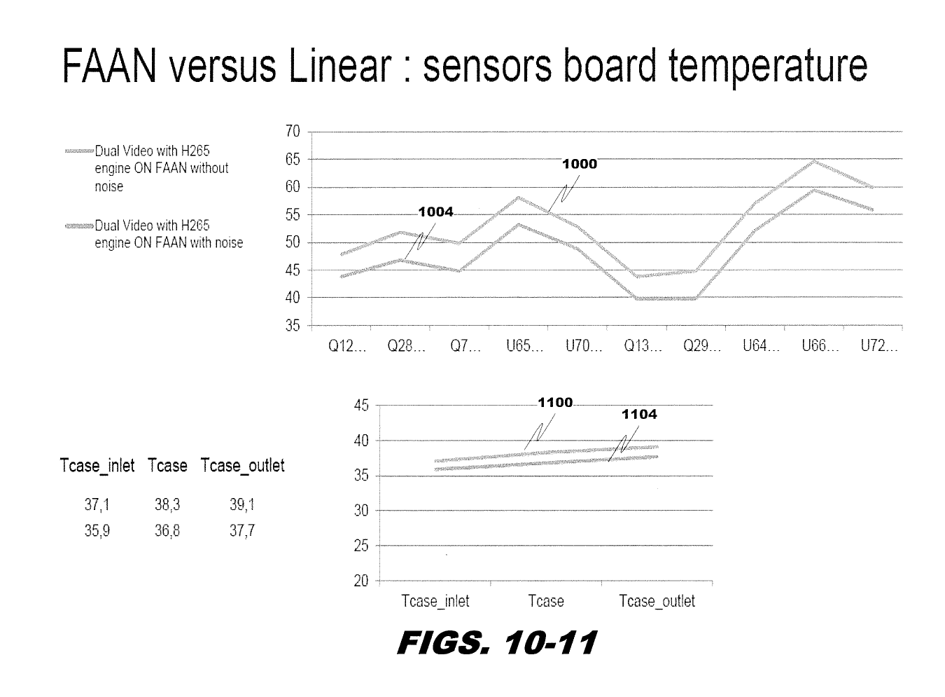

FIG. 10 shows the interior casing temperature curve form 1004 using the lookup tables 600 and 700 jointly (Dual Video with H265 engine ON FAAN with noise) as opposed to the curve form 1000 for fan noise using only the lookup table 700 (Dual Video with H265 engine ON FAAN without noise). FIG. 11 shows the interior case temperature curve forms 1104 and 1100 (with and without noise modification respectively) at the inlet (Tcase_inlet) 156, within the case (Tcase) 160, and at the outlet (Tcase_outlet) 152.

FIGS. 10-11 show that the interior case temperatures with noise modification are consistently less than that for without noise modification.

These figures show that, when a user is speaking, the fan can run at higher speeds without disturbing the user up to a certain decibel noise level and does not continue to increase in speed (which would be audible to the user). The multiple sensors are designed so that the user does not hear the fan. The fan also runs when the device is operating but not in use if needed, such as night or when no user is in spatial proximity to the device. The fan control system can be used in all electronics and adapted for use in different applications. For example, when the computational device is near a user's face, it is more important that the fan stays quiet when in such close facial proximity. When ambient temperature is too high or the device is not being cooled enough, the control system can be overridden once it passes a selected threshold.

Examples of the processors and microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

The exemplary systems and methods of this disclosure have been described in relation to a computational device. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a computational device, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others. For example in one alternative embodiment, Other sets of rules are possible depending on the application.

For example, the fan speed can be decreased in response to ambient noise falling below an ambient noise threshold or a person being sensed in spatial proximity to the computational device 100. This will reduce the fan noise when the user is most sensitive to noise. While the fan speed remains proportional to the interior casing temperature, the fan speed is decreased by a factor based on a low level of measured ambient noise. The ambient noise reduction can be overridden if the interior casing temperature exceeds a predetermined level.

In another alternative embodiment, the use of ambient noise measurements and/or user proximity detection to gate and control fan speed (up or down) are combined.

An exemplary set of rules in this example are as follows:

When the sensed interior casing temperature is less than a first temperature threshold or the measured ambient noise level is no more than a first noise threshold, the fan speed is decreased below the value in the fan lookup table, typically by an appropriate fraction from a third lookup table which indexes noise against a fan speed decrease factor.

When the sensed interior casing temperature is greater than the first temperature threshold and the measured ambient noise level is more than the first noise threshold, the fan is operated in accordance with the appropriate fan setting from the fan setting lookup table 700 increased by the appropriate multiplication factor from the lookup table 600.

When the sensed interior casing temperature is greater than a second temperature threshold or when a person is not sensed or deemed to be in spatial proximity to the computational device 100, the fan is operated in accordance with the fan lookup table 700 regardless of the measured ambient noise level. Alternatively, when this rule applies the fan can be operated in accordance with the noise and fan lookup tables 600 and 700 to provide reduced case components operating temperatures . . . .

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A cooling system for a computational device, comprising:
a thermal sensor to sense a temperature in an interior of the computational device;
a sensor to sense a parameter other than temperature of the interior;
a fan to cool a component of the computational device;
a microprocessor; and
a computer readable medium comprising fan control rules, wherein the fan control rules cause the microprocessor to modulate a speed of the fan based on the sensed interior temperature and sensed parameter other than temperature.

2. The cooling system of claim 1, wherein the sensor is a sound sensor and the sensed parameter is a noise level in proximity to the computational device, wherein the noise level is filtered to remove at least most of the noise emitted by the fan, and wherein the microprocessor increases a speed of the fan in response detecting a noise level in proximity to the computational device greater than a selected magnitude.

3. The cooling system of claim 1, wherein the sensor is a sound sensor and the sensed parameter is a noise level in proximity to the computational device, wherein the noise level is filtered to remove at least most of the noise emitted by the fan, and wherein the microprocessor decreases a speed of the fan in response to detecting a noise level in proximity to the computational device less than a selected magnitude.

4. The cooling system of claim 1, wherein the sensor is a human proximity sensor and the sensed parameter is a presence or absence of a human user in spatial proximity to the computational device and wherein the microprocessor increases a speed of the fan in response detecting the absence of a human user in spatial proximity to the computational device.

5. The cooling system of claim 1, wherein the sensor is a human proximity sensor and the sensed parameter is a presence or absence of a human user in spatial proximity to the computational device and wherein the microprocessor decreases a speed of the fan in response detecting the presence of a human user in spatial proximity to the computational device.

6. The cooling system of claim 2, wherein the microprocessor determines a fan setting corresponding to the measured temperature, a factor corresponding to the sensed parameter to increase the fan setting, and an increased fan setting to cause the fan to increase the fan speed.

7. A computational device, comprising:
a microprocessor;
a heat generating integrated circuit in an interior of the computational device; and
a cooling system comprising:
a thermal sensor to sense a temperature in an interior of the computational device;
a sensor to sense a parameter other than temperature of the interior;
a fan to cool a component of the computational device; and
a computer readable medium comprising fan control rules, wherein the fan control rules cause the microprocessor to vary a speed of the fan based on the sensed interior temperature and sensed parameter other than temperature.

8. The computational device of claim 7, wherein the sensor is a sound sensor and the sensed parameter is a noise level in proximity to the computational device, wherein the noise level is filtered to remove at least most of the noise emitted by the fan, and wherein the microprocessor increases a speed of the fan in response detecting a noise level in proximity to the computational device greater than a selected magnitude.

9. The computational device of claim 7, wherein the sensor is a sound sensor and the sensed parameter is a noise level in proximity to the computational device, wherein the noise level is filtered to remove at least most of the noise emitted by the fan, and wherein the microprocessor decreases a speed of the fan in response to detecting a noise level in proximity to the computational device less than a selected magnitude.

10. The computational device of claim 7, wherein the sensor is a human proximity sensor and the sensed parameter is a presence or absence of a human user in spatial proximity to the computational device and wherein the microprocessor increases a speed of the fan in response detecting the absence of a human user in spatial proximity to the computational device.

11. The computational device of claim 7, wherein the sensor is a human proximity sensor and the sensed parameter is a presence or absence of a human user in spatial proximity to the computational device and wherein the microprocessor decreases a speed of the fan in response detecting the presence of a human user in spatial proximity to the computational device.

12. The computational device of claim 8, wherein the microprocessor determines a fan setting corresponding to the measured temperature, a factor corresponding to the sensed parameter to increase the fan setting, and an increased fan setting to cause the fan to increase the fan speed.

13. A method for cooling a computational device, comprising:
providing a thermal sensor to determine a temperature in an interior of the computational device, a sensor to determine at least one of a noise level in proximity to the computational device or a presence or absence of a human user in spatial proximity to the computational device, a fan to cool a component of the computational device, a microprocessor, and a computer readable medium comprising fan control rules; and
increasing, by the microprocessor, a speed of the fan in response detecting a noise level in proximity to the computational device greater than a selected magnitude or an absence of a human user in spatial proximity to the computational device.

14. The method of claim 13, wherein the sensor is a sound sensor that determines a noise level in proximity to the computational device, wherein the noise level is filtered to remove at least most of the noise emitted by the fan, and wherein the microprocessor increases a speed of the fan in response detecting a noise level in proximity to the computational device greater than a selected magnitude.

15. The method of claim 13, wherein the sensor is a sound sensor that determines a noise level in proximity to the computational device, wherein the noise level is filtered to remove at least most of the noise emitted by the fan, and further comprising:
decreasing, by the microprocessor, the speed of the fan in response to detecting a noise level in proximity to the computational device less than a selected magnitude.

16. The method of claim 13, wherein the sensor is a human proximity sensor that determines the presence or absence of a human user in spatial proximity to the computational device, and further comprising:
decreasing, by the microprocessor, the speed of the fan in response to detecting a presence of a human user in spatial proximity to the computational device.

17. The method of claim 13, wherein the sensor is a human proximity sensor that determines the presence or absence of a human user in spatial proximity to the computational device and wherein the microprocessor decreases a speed of the fan in response detecting the presence of a human user in spatial proximity to the computational device.

18. The method of claim 14, wherein the microprocessor determines a fan setting corresponding to the measured temperature, a factor to increase the fan setting, and an increased fan setting to cause the fan to increase the fan speed.

19. The method of claim 13, wherein the human proximity sensor is a clock that assumes a person is in spatial proximity to the computational device during selected business hours and is not in spatial proximity to the computational device outside of selected business hours.

20. The method of claim 13, wherein the human proximity sensor determines whether or not a person is physically within a spatial distance of the computational device.
